(19) United States
(12) Patent Application Publication
(10) Pub. No.: US 2021/0331407 A1
(43) Pub. Date: Oct. 28, 2021

(54) TACTILE DIAGNOSTIC PARTS

(71) Applicant: Hewlett-Packard Development Company, L.P., Spring, TX (US)

(72) Inventor: Alexandra Ling Ju, Palo Alto, CA (US)

(21) Appl. No.: 16/606,445

(22) PCT Filed: Apr. 18, 2018
(86) PCT No.: PCT/US2018/028159

§ 371 Date: Oct. 18, 2019

(51) Int. Cl. B29C 64/393; B29C 64/153; B33Y 10/00; B33Y 50/02; B33Y 80/00

(52) U.S. Cl. CPC B29C 64/393; B29C 64/153; B33Y 80/00; B33Y 50/02; B33Y 10/00

(57) ABSTRACT

In example implementations, a tactile diagnostic part is provided. The tactile diagnostic part includes an array of a plurality of tactile diagnostic parts. The tactile diagnostic parts are to diagnose a printing variability in different locations of a print bed of a three dimensional printer before printing a part. Each one of the plurality of diagnostic parts includes a first component that includes a flexible exterior shell and a second component that includes a resistive structure inside of the flexible exterior shell of the first component.

### BACKGROUND

Three dimensional (3D) printers are printers that are used to print three dimensional objects, structures, or parts. A design of an object may be uploaded into the 3D printer. The 3D printer may then print the object based on the uploaded design.

3D printers may perform additive printing or subtractive printing. In additive printing, the 3D printer may have a bed that holds a powder or material. The powder may be dispensed on the bed in a desired pattern. An agent may be applied to the powder and heat may be applied to cure the agent and the powder. The process may be repeated for each layer.

### BRIEF DESCRIPTION OF THE DRAWINGS

FIG. 1 is a block diagram of an example of 3D printer of the present disclosure;

FIG. 2 is a top view of an array of tactile diagnostic parts of the present disclosure;

FIG. 3 is a side view of a tactile diagnostic part of the present disclosure;

FIG. 4 is a side cross-sectional view of a tactile diagnostic part of the present disclosure;

FIG. 5 is a flow chart of an example method for diagnosing operation of a 3D printer with a tactile diagnostic part of the present disclosure; and

FIG. 6 is a block diagram of an example non-transitory computer readable storage medium storing instructions executed by a processor of the present disclosure.

### DETAILED DESCRIPTION

Examples described herein provide tactile diagnostic parts and methods for producing and using the same. As discussed above, 3D printers are used to print 3D objects or parts. The 3D printers can have many different variables that can affect how well the part is printed. For example, the variables can include print orientation, placement in the print bed, how the parts are packed together, a print mode, and the like. The quality of the printed part may also depend on variables, such as fusing, time, annealing, cooling, and the like. Other unexpected variations may originate from different build trolleys, differences between different 3D printers, environmental conditions, batches of powder or materials, and the like.

Examples herein provide a tactile diagnostic part that can be printed to diagnose operation of the 3D printer. The tactile diagnostic part may be printed in an array that is the same size as the print bed. The array of tactile diagnostic parts may allow a user to feel which locations may not be printing as desired. Based on the diagnosis, adjustments to the 3D printer may be made and the process may be repeated or the part may be printed in particular location of the print bed.

In one example, the size and number of the tactile diagnostic parts that are printed may be a function of a material being used to print a part, a size of the part being printed, and/or a resolution of the 3D printer. For example, for parts with high resolution, each tactile diagnostic part may be relatively small in the array. For parts with low resolution that may be large, each tactile diagnostic part may be relatively large in the array.

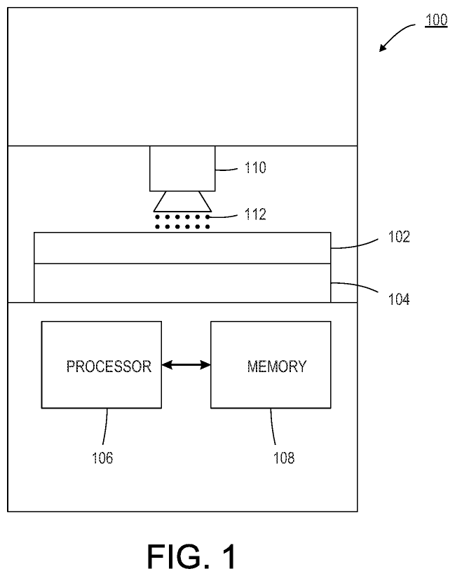

FIG. 1 illustrates a block diagram of a three dimensional (3D) printer 100 that can print an array of a plurality of tactile diagnostic parts 102 (also referred to as the array 102) of the present disclosure. In one example, the 3D printer 100 may include a print bed 104. A printhead 110 may dispense a material 112 onto the print bed 104 for printing a desired part or the array of the plurality of tactile diagnostic parts 102. The material 112 may be a powder or any type of material suitable for 3D printing.

Although the 3D printer 100 illustrates an example of additive 3D printing, it should be noted that the 3D printer 100 may also print by subtractive 3D printing. Although a single printhead 110 is illustrated in FIG. 1, it should be noted that any number of printheads 110 may be deployed.

It should be noted that the 3D printer 100 has been simplified for ease of explanation. The 3D printer may include additional components, such as a heater to cure each layer of the material 112 that is printed, a printhead to dispense a curing agent, a user interface to receiving inputs and provide outputs, and the like.

In one example, the 3D printer 100 may include a processor 106 and a memory 108. The processor 106 may be communicatively coupled to the printhead 110 and the memory 108. The processor 106 may execute instructions stored in the memory 108 to print the array of the plurality of tactile diagnostic parts 102, or any other desired part.

The memory 108 may be any non-transitory computer readable storage medium. For example, the memory 108 may be a hard disk drive, a solid state drive, a random access memory (RAM), a read only memory (ROM), and the like. The memory 108 may store instructions that are executed by the processor 106. The memory 108 may also store other information such as recipes for different types of arrays of the plurality of tactile diagnostic parts 102 based on a part that may be printed, as discussed in further detail below.

In one example, the array of the plurality of tactile diagnostic parts 102 can be used to provide diagnostic information of the 3D printer 100. The diagnostic information may provide tactile feedback related to different variables of the 3D printer.

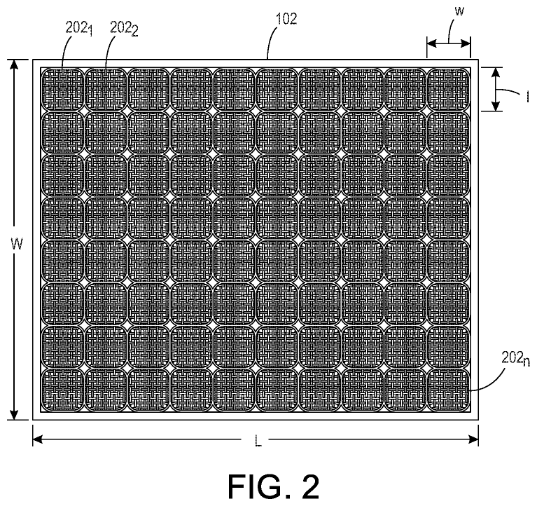

FIG. 2 illustrates a top view of an example of the array of the plurality of tactile diagnostic parts 102. The array 102 may include tactile diagnostic parts 202₁ to 202ₙ (hereinafter referred to individually as a tactile diagnostic part 202 or collectively as tactile diagnostic parts 202). The array 102 may have a width “W” and a length “L” that is approximately equal to the width and length of the print bed 104. Thus, the array 102 may be able to provide diagnostic information for all printable areas in the 3D printer.

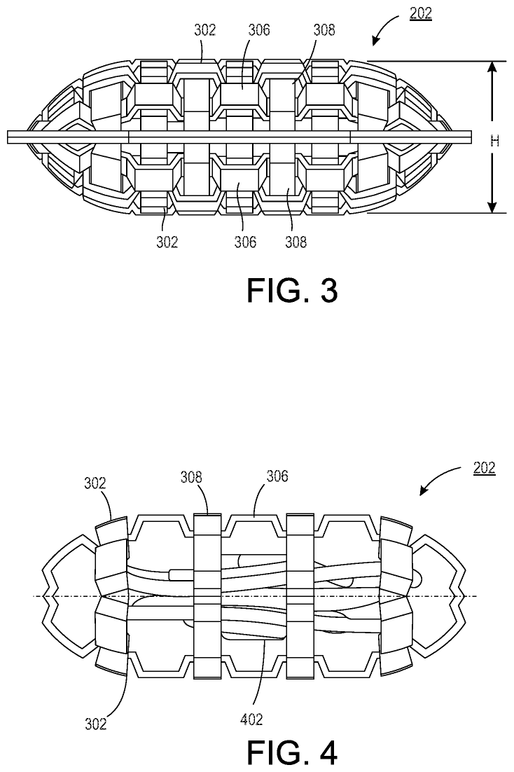

In one example, each tactile diagnostic part 202 may have a width “w,” a length “I,” and a height “H” (shown in FIG. 3). The height “H” may also be the height of the overall array 102.

The width, the length, and the height of the tactile diagnostic parts 202 may be the same for each tactile diagnostic part 202 in the array 102. In one example, the width, the length, and the height of the tactile diagnostic part 202 may be a function of the resolution of the 3D printer 100. The resolution of the 3D printer 100 may be defined by dimensions of a voxel size (e.g., a pixel for the 3D printer) that can be printed by the 3D printer 100.

In one example, the width, the length, and the height of each tactile diagnostic part 202 may be a function of a size of a part that is to be printed. For example, if the part is relatively small with a lot of details, then the width, the length, and the height of each tactile diagnostic part 202 may be relatively small. If the part to be printed is relatively large with less details, then the width, the length, and the height of each tactile diagnostic part 202 may be relatively large.

Although FIG. 2 illustrates the array 102 having a tactile diagnostic part 202 in every portion of the array 102, it should be noted that the tactile diagnostic parts 202 may be printed in limited portions of the array 102. For example, if the top half of the print bed 104 is known to have printing variability, the top half of the array 102 may include the tactile diagnostic parts 202. The bottom half of the array 102 may be a flat sheet or without the tactile diagnostic parts 202. In other words, the tactile diagnostic parts 202 may be printed in the array 102 at locations that correspond with known variable locations in the print bed 104.

In one example, the dimensions of the tactile diagnostic part 202 may also be a function of the material 112 that is used to print a part. For example, more dense materials 112 may have large dimensions for each tactile diagnostic part 202 and less dense materials 112 may have smaller dimensions for each tactile diagnostic part 202.

In one example, the dimensions for each part to be printed, each material 112 used to print, a particular location of the print bed 104, or any combination thereof, may be stored in the memory 108. For example, the part to be printed (along with a size of the part and amount of detail), a material 112 being used, and the like, may be entered via a user interface of the 3D printer 100. Based on the provided information, the proper dimensions for each tactile diagnostic part 202 may be obtained from the memory 108. The processor 106 may then control the 3D printer to print the array 102 with tactile diagnostic parts 202 that have dimensions obtained from the memory 108.

As noted above, the tactile diagnostic parts 202 in the array 102 may be used to provide diagnostic information related to the 3D printer. For example, the tactile diagnostic part 202 may be printed to provide tactile feedback. Based on the tactile feedback, information about the 3D printer may be obtained. The information may include variability related to whether the current temperature setting is correct for curing the material 112, whether the amount of material 112 at each location is being properly dispensed, whether an amount of time that heat is being applied is correct, whether certain locations on the print bed 104 have more printing variability than other locations on the print bed 104, and the like.

The information may be obtained based on an amount of compression of the tactile diagnostic part 202 when pressure is applied to the tactile diagnostic part 202. In one example, an amount of compression measured for a control tactile diagnostic part that is printed with known correct parameters may be stored in the memory 108 for each combination of part being printed and material 112 being used. The compression may be measured for the tactile diagnostic part 202 and compared to the amount of compression for the control tactile diagnostic part.

In one example, the array 102 may be fed to a machine to measure the compression for each tactile diagnostic part 202. The machine may apply a pre-defined amount of pressure to each tactile diagnostic part 202 and measure the amount of compression. The amount of compression may be compared to the amount of compression for the control tactile diagnostic part to determine at least one adjustment for the 3D printer 100.

In another example, a technician may manually press each tactile diagnostic part 202 to “feel” the amount of compression. The technician may then collect information based on pressing each tactile diagnostic part 202 to determine at least one adjustment for the 3D printer 100.

In one example, the adjustment may be to adjust a parameter at a particular location associated with a particular tactile diagnostic part 202. For example, a location associated with the tactile diagnostic part 202₁ may have an undesirable amount of compression. Thus, an operating parameter at the location over the print bed 104 associated with the tactile diagnostic part 202₁ may be adjusted. The operating parameter may be a temperature, an amount of curing time, an amount of material 112 dispensed at that location, and the like. Then the desired part may be printed after the adjustments are made to the 3D printer.

In one example, the adjustment may be to print the desired part on a particular location of the print bed 104 based on information collected from each tactile diagnostic part 202 of the array 102. For example, some 3D parameters may not be able to make operational adjustments. Thus, if the tactile diagnostic parts 202 in the bottom right hand corner of the array 102 have the least amount of variability, then the desired part may be printed in the bottom right hand corner of the print bed 104.

FIG. 3 illustrates a side view of the tactile diagnostic part 202. FIG. 3 illustrates an overall height “H” of the tactile diagnostic part 202, as discussed above.

In one example, the tactile diagnostic part 202 may comprise a first component 302. The first component 302 may be a flexible exterior shell. The flexible exterior shell may be formed by a woven-structure, or a cross-hatching pattern, formed by strips 306 and 308 of the printed material 112. For example, the strips 306 may run horizontally in a first direction and the strips 308 may run vertically in a second direction. The strips 306 may alternate going over and under the strips 308 and vice versa.

Although FIG. 3 illustrates the first component 302 as a woven-structure, it should be noted that any flexible structure can be deployed. For example, the first component 302 may be a solid exterior shell that is relatively thin to allow the exterior shell to be flexible.

FIG. 4 illustrates a partial cross-sectional side view of the tactile diagnostic part 202. FIG. 4 illustrates a second component 402 of the tactile diagnostic part 202. The second component 402 may be inside of the first component 302. For example, the second component 402 may be a resistive structure that is enclosed by the flexible exterior shell.

In one example, the resistive structure may be spring structure that can provide resistance against an applied pressure. Said another way, the resistive structure can return to an initial state after being compressed, similar to a spring. Although FIG. 4 illustrates the resistive structure being a coil-like structure, the resistive structure may have other shapes, such as for example, a hollow sphere, or any other similar structures.

As a result, the design of the tactile diagnostic part 202 allows printing variation in a 3D printer 100 to be measured. For example, the flexible outer shell and the resistive structure inside of the flexible outer shell may provide a feedback. An amount of compression of the tactile diagnostic part 202 may provide information related to the printing variations in different locations of the print bed 104 in the 3D printer 100. Based on the information collected from the tactile diagnostic part 202 in the array 100, adjustments can be made for printing a desired part in the 3D printer 100.

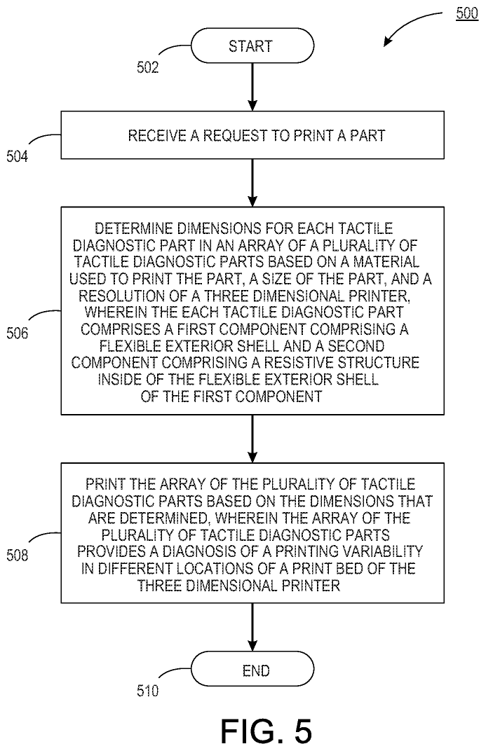

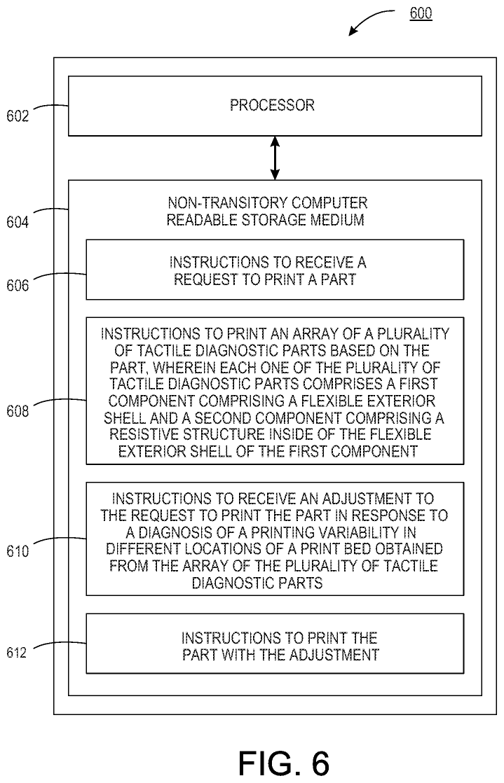

FIG. 5 illustrates a flow diagram of an example method 500 for diagnosing operation of a 3D printer with a tactile diagnostic part. In one example, the method 500 may be performed by the 3D printer 100, or the apparatus 600 illustrated in FIG. 6 and described below.

At block 502, the method 500 begins. At block 504, the method 500 receives a request to print a part. For example, a user may enter a part number, description, part name, and the like, via a user interface of the 3D printer.

At block 506, the method 500 determines dimensions for each tactile diagnostic part in an array of a plurality of tactile diagnostic parts based on a material used to print the part, a size of the part, and a resolution of a three dimensional printer, wherein the each tactile diagnostic part comprises a first component comprising a flexible exterior shell and a second component comprising a resistive structure inside of the flexible exterior shell of the first component. For example, the part to be printed that is entered in block 502 may be associated with a particular material, have a particular size, an amount of detail, a particular resolution, and the like. Based on the part to be printed, dimensions associated with each tactile diagnostic part may be obtained from memory of the 3D printer.

As discussed above, the tactile diagnostic part may comprise the flexible exterior shell and the resistive structure. The flexible exterior shell may be formed from a woven structure of strips of printed material or any other flexible structure design for the outer shell. The resistive structure may be a spring like structure. For example, the resistive structure may be shaped in a coil, a hollow sphere, or any other type resistive structure.

At block 508, the method 500 prints the array of the plurality of tactile diagnostic parts based on the dimensions that are determined, wherein the array of the plurality of tactile diagnostic parts provides a diagnosis of a printing variability in different locations of a print bed of the three dimensional printer. The 3D printer may print the array of the plurality of tactile diagnostic parts with the same material that is used to print the part that is to be printed.

The array of the plurality of tactile diagnostic parts may provide information related to the printing variability of the 3D printer. For example, the tactile diagnostic parts may be analyzed by compressing each tactile diagnostic part and measuring an amount of compression. For example, the array of the plurality of diagnostic parts may be placed in an analysis machine that can apply a pre-defined amount of pressure to each one of the tactile diagnostic parts. The amount of compression may be measured for each tactile diagnostic part. The amount of compression may provide information related to printing variability at each location associated with a respective tactile diagnostic part.

In another example, a technician may press each tactile diagnostic part and “feel” the amount of compression. Based on the “feel”, the technician may be able to obtain information related to the printing variability at each location associated with a respective tactile diagnostic part.

As discussed above, the diagnosis of the printing variability of the 3D printer may be used to determine an adjustment to the 3D printer. In one example, the adjustment may be changing an operating parameter of the 3D printer. For example, the operating parameter may be a temperature that is applied, an amount of time that the material is cured, a type of material that is used for printing, and the like.

In one example, the adjustment may be specifying a location on the print bed of the 3D printer to print the part. For example, if the array of the plurality of tactile diagnostic parts indicates that a particular location of the print bed has low variability, then the part may be printed in the particular location. The part may then be printed based on the adjustment.

In one example, the method 500 may be repeated after the adjustment is made. For example, the array of the plurality of tactile diagnostic parts may be printed again for the part. The array of the plurality of diagnostic parts may then be analyzed, or examined, again. The part may be printed when the information obtained from the array of the plurality of tactile diagnostic parts indicates that printing variability of the 3D printer at select locations, or all locations, is within a pre-defined threshold. For example, the pre-defined threshold may be a value that represents a minimum allowable difference in the amount of compression of the tactile diagnostic part and a control tactile diagnostic part, as described above. At block 510, the method 500 ends.

FIG. 6 illustrates an example of an apparatus 600. In one example, the apparatus 600 may be the 3D printer 100. In one example, the apparatus 600 may include a processor 602 and a non-transitory computer readable storage medium 604. The non-transitory computer readable storage medium 604 may include instructions 606, 608, 610, and 612 that, when executed by the processor 602, cause the processor 602 to perform various functions.

In one example, the instructions 606 may include instructions to receive a request to print a part. The instructions 608 may include instructions to print an array of a plurality of tactile diagnostic parts based on the part, wherein each one of the plurality of tactile diagnostic parts comprises a first component comprising a flexible exterior shell and a second component comprising a resistive structure inside of the flexible exterior shell of the first component. The instructions 610 may include instructions to receive an adjustment to the request to print the part in response to a diagnosis of a printing variability in different locations of a print bed obtained from the array of the plurality of tactile diagnostic parts. The instructions 612 may include instructions to print the part with the adjustment.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A tactile diagnostic part, comprising:
an array of a plurality of tactile diagnostic parts to diagnose a printing variability in different locations of a print bed of a three dimensional printer before printing a part, wherein each one of the plurality of tactile diagnostic parts, comprises:
a first component comprising a flexible exterior shell; and
a second component comprising a resistive structure inside of the flexible exterior shell of the first component.

2. The tactile diagnostic part of claim 1, wherein the array comprises a width and a length that is equal to a width and a length of the print bed.

3. The tactile diagnostic part of claim 1, wherein dimensions of each one of the plurality of tactile diagnostic parts is a function of a resolution of the three dimensional printer.

4. The tactile diagnostic part of claim 1, wherein dimensions of each one of the plurality of tactile diagnostic parts is a function of a size of a part that is to be printed in the three dimensional printer.

5. The tactile diagnostic part of claim 1, wherein the flexible exterior shell comprises a woven-structure.

6. The tactile diagnostic part of claim 1, wherein the resistive structure comprises a spring coil shape.

7. The tactile diagnostic part of claim 1, wherein the array of the plurality of tactile diagnostic parts is printed with a same material used to print the part.

8. A non-transitory computer readable storage medium encoded with instructions executable by a processor, the non-transitory computer-readable storage medium comprising:
instructions to receive a request to print a part;
instructions to print an array of a plurality of tactile diagnostic parts based on the part, wherein each one of the plurality of tactile diagnostic parts, comprises a first component comprising a flexible exterior shell and a second component comprising a resistive structure inside of the flexible exterior shell of the first component;
instructions to receive an adjustment to the request to print the part in response to a diagnosis of a printing variability in different locations of a print bed obtained from the array of the plurality of tactile diagnostic parts; and
instructions to print the part with the adjustment.

9. The non-transitory computer readable storage medium of claim 8, wherein different dimensions for the plurality of tactile diagnostic parts are stored for different parts.

10. The non-transitory computer readable storage medium of claim 8, wherein the instructions to print the array of the plurality of tactile diagnostic parts based on the part is based on a resolution and a size of the part.

11. The non-transitory computer readable storage medium of claim 8, wherein the adjustment comprises changing an amount of heat at a location associated with one of the plurality of tactile diagnostic parts.

12. The non-transitory computer readable storage medium of claim 8, wherein the adjustment comprises specifying a location on the print bed to print the part.

13. A method, comprising:
receiving, by a processor, a request to print a part;
determining, by the processor, dimensions for each tactile diagnostic part in an array of a plurality of tactile diagnostic parts based on a material used to print the part, a size of the part, and a resolution of a three dimensional printer, wherein the each tactile diagnostic part comprises a first component comprising a flexible exterior shell and a second component comprising a resistive structure inside of the flexible exterior shell of the first component; and
printing, by the processor, the array of the plurality of tactile diagnostic parts based on the dimensions that are determined, wherein the array of the plurality of tactile diagnostic parts provides a diagnosis of a printing variability in different locations of a print bed of the three dimensional printer.

14. The method of claim 13, further comprising:
receiving, by the processor, an adjustment to the request to print the part; and
printing, by the processor, the part based on the adjustment.

15. The method of claim 13, wherein a size of the array is equal to a size of the print bed, wherein the plurality of tactile diagnostic parts are located in the array in locations that correspond to known variable locations in the print bed.
